(19) United States
(12) Patent Application Publication
(10) Pub. No.: US 2026/0361720 A1
(43) Pub. Date: Nov. 12, 2026

(54) REDUCTION IN LIMITATIONS BASED ON COMPLETION OF RECOMMENDED ACTIVITY

(71) Applicant: The Toronto-Dominion Bank, Toronto (CA)

(72) Inventors: Dhiren Kakkar, Toronto (CA); Rashik Habib, Toronto (CA); Sheldon Lu-Ming Tung, Markham (CA); Jean-Christophe Bouëtté, Montreal (CA); Anna Keshabyan-Prasad, Maple Ridge (CA)

(73) Assignee: The Toronto-Dominion Bank, Toronto, ON (CA)

(21) Appl. No.: 19/201,995

(22) Filed: May 8, 2025

(51) Int. Cl. H04L 9/40; H04L 67/1396; H04L 67/306

(52) U.S. Cl. CPC H04L 63/102; H04L 67/1396; H04L 67/306

(57) ABSTRACT

Please replace the original Abstract as filed with the below amended Abstract.

An example operation may include at least one of executing an artificial intelligence (AI) model on historical profile data and on historical restrictions to train the AI model to recommend actions to take to modify restrictions applied to profiles, generating a digital record of use of a profile with a software application over time, the profile comprising at least one restriction applied thereto, determining an action for the profile to take to reduce the at least one restriction based on execution of the trained AI model on the digital record, and, in response to occurrence of the action, modifying the at least one restriction applied to the profile to allow additional use. The example operation may further include an AI agent that performs an action based on the at least one modified restriction.

### BACKGROUND

Software often provides its users with the ability to create accounts or profiles which the user can then store information about themselves. In some cases, profiles may include or may be tied to payment accounts, user accounts, work accounts, security accounts, and the like, which can store additional data within the profiles such as activity of a user when using the profile include historical actions taken by the user. Restrictions, or limitations, are often applied to profiles to prevent certain use with the profile. However, often these limitations are based on generic data that is not specific to the user, stale data, incorrect data, etc. about the user.

### SUMMARY

One example embodiment provides an apparatus that may include a memory, and at least one processor communicably coupled to the memory, where the at least one processor may execute an artificial intelligence (AI) model on historical profile data and historical restrictions to train the AI model to recommend actions to take to modify restrictions applied to profiles, generate a digital record of use of a profile with a software application over time, the profile comprising at least one restriction applied thereto, determine an action for the profile to take to reduce the at least one restriction based on execution of the trained AI model on the digital record, and in response to occurrence of the action, modify the at least one restriction applied to the profile to allow additional use.

Another example embodiment provides a method that includes one or more of executing an artificial intelligence (AI) model on historical profile data and historical restrictions to train the AI model to recommend actions to take to modify restrictions applied to profiles, generating a digital record of use of a profile with a software application over time, the profile comprising at least one restriction applied thereto, determining an action for the profile to take to reduce the at least one restriction based on execution of the trained AI model on the digital record, and in response to occurrence of the action, modifying the at least one restriction applied to the profile to allow additional use.

A further example embodiment provides a computer-readable medium comprising instructions, that when read by a processor, cause the processor to perform one or more of executing an artificial intelligence (AI) model on historical profile data and historical restrictions to train the AI model to recommend actions to take to modify restrictions applied to profiles, generating a digital record of use of a profile with a software application over time, the profile comprising at least one restriction applied thereto, determining an action for the profile to take to reduce the at least one restriction based on execution of the trained AI model on the digital record, and in response to occurrence of the action, modifying the at least one restriction applied to the profile to allow additional use.

### BRIEF DESCRIPTION OF DRAWINGS

FIG. 1A is a diagram illustrating a computing environment for modifying restrictions and limitations with a profile according to examples and features of the instant solution.

FIG. 1B is a diagram illustrating a process of generating a recommended action to take to reduce a restriction in the profile according to examples and features of the instant solution.

FIG. 1C is a diagram illustrating a process of detecting that a recommended action has been completed and modifying a profile in response according to examples and features of the instant solution.

FIG. 1D is a diagram illustrating a process of using the modified profile during subsequent processing according to examples and features of the instant solution.

FIG. 2A is a system diagram illustrating integration of an AI model into any decision point, according to the examples and features of the instant solution.

FIG. 2B is a diagram illustrating a process for developing an AI model that supports AI-assisted computer decision points, according to the examples and features of the instant solution.

FIG. 2C is a diagram illustrating a process for utilizing an AI model that supports AI-assisted computer decision points according to examples and features of the instant solution.

FIG. 2D is a system diagram illustrating a process of a chatbot service that utilizes an AI model.

FIG. 3 is a system diagram illustrating an operating environment for a communication service according to the examples and features of the instant solution.

FIG. 4 is a diagram illustrating a process of generating a notification and pushing the notification to a computing device according to the examples and features of the instant solution.

FIG. 5 is a diagram illustrating a process of changing settings within a software application for a profile and changing a storage location of the profile within a storage device according to the examples and features of the instant solution.

FIG. 6 is a diagram illustrating a process of generating a feedback record and retraining an AI model according to the examples and features of the instant solution.

FIG. 7A is a diagram illustrating a method of modifying a restriction applied to a profile according to the examples and features of the instant solution.

FIG. 7B is a diagram illustrating an additional method of modifying a restriction applied to a profile according to the examples and features of the instant solution.

FIG. 8 is a diagram illustrating a computing system that may be used in any of the example embodiments described herein.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

A software application, system, or the like, may implement restrictions on profiles for security purposes and other purposes. A profile may initially receive default or initial restrictions (eg., limitations on use of the profile, limitations on security of the profile, limitations on storage, limitations on use, etc.) that prevent the profile from being used to perform certain actions, functions, or the like, through a software application, system, and the like. Over time, the profile may be used in a manner that demonstrates the profile deserves more responsibilities, less restrictions, less limitations, or the like. However, detecting the occurrence of such responsible behavior is typically done by a human.

In the example embodiments, an artificial intelligence (AI) system can analyze a digital record of activity of a profile and generate recommended actions for the profile to perform or otherwise achieve to have one or more restrictions reduced, removed, or otherwise modified. The AI system may also analyze how much time it takes for the profile to complete or otherwise achieve the action, and retrain the AI model based on this timing to further ensure that a reasonable amount of time is generated in future predictions. Here, the predicted time may be compared to a target time. The target time may be defined by a user within the software, hardcoded in the software, and the like.

Some of the technical benefits of the example embodiments include tracking profile activity and usage using digital records and ensuring that the digital record is secure, analyzing the digital record to identify actions to take that can reduce restrictions on the profile using artificial intelligence in real-time. For example, each time the profile is used to perform an action through a system or through a software application, the AI system may be called to analyze the digital record of the profile to detect if any restrictions or limitations can be reduced or otherwise removed. This includes limits on access to data, storage, funding, money, etc.

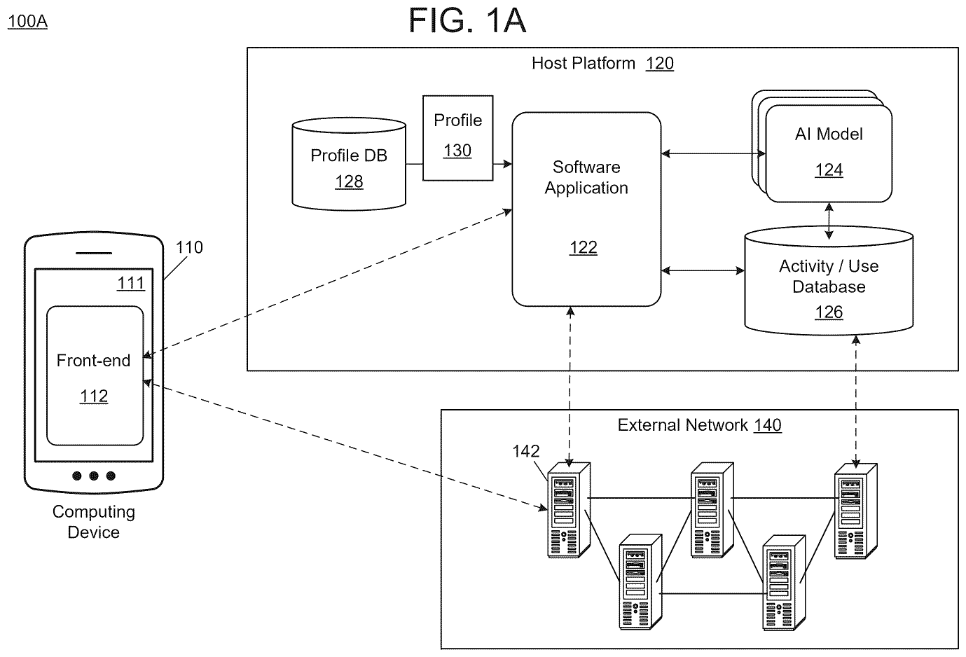

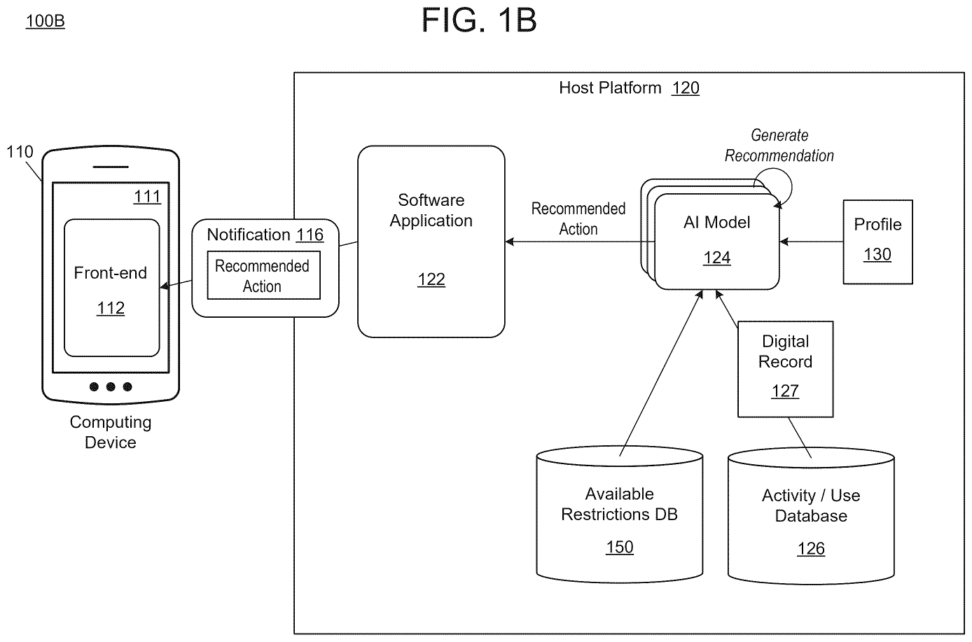

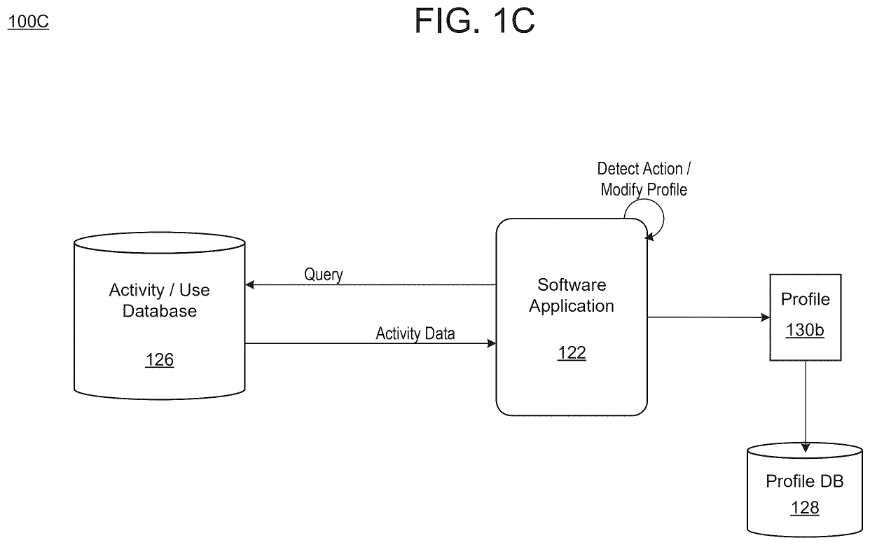

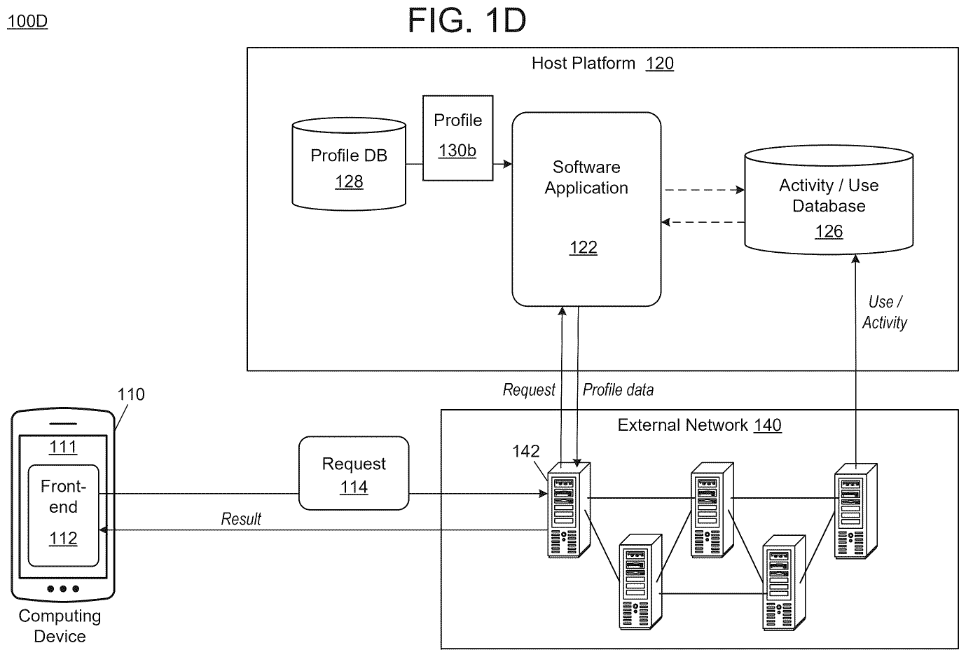

FIG. 1A illustrates a computing environment 100A for modifying restrictions and limitations with a profile according to examples and features of the instant solution. Referring to FIG. 1A, a software application 122 is hosted by a host platform 120. Here, the host platform 120 may be a cloud platform, a web server, a distributed system, or the like. The software application 122 may be a mobile application, a web application, and the like. A user may access the software application 122, for example, by downloading a front-end 112 of the software application 122 onto the computing device 110, or the like. As another example, a user may access the software application 122 by entering an IP address, URL, website name, etc. into a browser on the computing device 110.

In this example, the user may access the front-end 112 of the software application 122 by viewing a display device 111 on the computing device 110. In some cases, the display device 111 may be a touch screen, enabling the user to input touch commands into a GUI of the front-end 112. As another example, a user may use a cursor/mouse, etc. The user may use the front-end 112 of the software application 122 to build a profile that is then stored at a back-end with the software application 122. For example, the software application 122 may manage the profiles by controlling what data is stored in the profiles. In some cases, a user may be able to access the profile and store data values by inputting them into the front-end 112. As another example, the user may be prevented from accessing the profile. In this case, the profile may be an internal profile that is managed by the system. In some cases, the profile may include a payment vehicle such as a digital wallet, a payment card, and the like.

According to various embodiments, the user may use a profile (e.g., profile 130) to perform various actions such as sending data, sending payment, sending messages, streaming data, downloading data, uploading data, accessing data, storing personal information, storing payment information, storing passwords, storing secret codes, storing usernames, and the like. In some embodiments, the use of the profile 130 may be locally within the host platform 120, and any other systems coupled thereto. The use of the profile 130 may be recorded in an activity database 126 which contains the usage of the profile. The usage may include a digital record of events, transactions, messages, activities, behavior, and the like, performed by the profile 130. The usage may include timestamps of occurrence enabling the software application 122 to identify periods of time that go by between an action being recommended an action being completed or otherwise achieved.

In some embodiments, the use of the profile 130 may be on a separate system, software application, network, or the like. For example, the profile 130 may be used to send communications on an external network 140. For example, the communications may include electronic messages, payments, data, voice, and the like. For example, the user may input commands to the front-end 112 which sends a request to a gateway node 142 of the external network 140 with a request for an action and an identifier of a user, a profile, an account or the like. The external network 140 may process the request from the profile 130. The results of the use of the profile 130 on the external network 140 may be recorded in the activity database 126.

FIG. 1B illustrates a process 100B of generating a recommended action to take to reduce a restriction in the profile according to examples and features of the instant solution. According to various embodiments, the software application 122 may continuously, periodically, reactively, proactively, and the like, execute a review process on a record of activity of the profile 130 stored in the activity database 126, and determine actions for the profile 130 to take to have the software application 122 remove certain limitations or restrictions, reduce certain limitations or restrictions, increase availability of credit or funds, increase functionality within the software application 122, increase available features within the software application 122, and the like.

The activity determination process may be performed in real-time. For example, the activity determination process may be performed by the software application 122 each time a new request to use the profile is received. As another example, the activity determination process may be performed on a recurring basis such as once a day, once a week, once a month, and the like. As another example, passage of time may trigger the execution of the activity determination process. For example, after the user has had their profile open and active for a year, the system may automatically perform the activity determination process.

Referring to FIG. 1B, the software application 122 may include at least one AI model 124 which is trained to recommend actions to take to reduce restrictions on a profile. In this example, the software application 122 may detect usage of the profile 130, and then query the AI model 124 to determine an activity that can be performed by the profile 130 to remove or reduce a restriction on the profile 130. Here, the software application 122 may cause a digital record 127 of activity, usage, etc. of the profile 130 to be input to the at least one AI model 124. In some embodiments, the software application 122 may also input available restrictions for the profile 130 which are associated with the software application 122 from a database 150. In response, the at least one AI model 124 may generate a recommended action for the profile 130 and send the recommended action to the software application 122. In response, the software application 122 may send a notification 116 to the computing device 110 with an identifier of the recommended action, a time frame, attributes of the recommended action, and the like.

The recommended action may include limiting usage of data, limiting usage of resources, limiting usage of credit, limiting usage of a system, and the like. As another example, the recommended action may include increasing usage of a resource, increasing usage of a stem, increasing usage of data, increasing usage of credit, and the like. As another example, the recommend action may include good behavior with the profile 130. For example, the recommendation may be that negative reports or other checks on the profile 130 do not occur, and the like.

In some embodiments, the activity may be performed, and a review/analysis may be performed on the activity and previous activity to determine whether to remove or reduce restrictions based on the activity performed and in some cases, previous activity performed. As another example, the review process may be performed once a day, a week, a month, or the like. In some cases, there may be no determination or no activity available for the profile to perform. For example, the profile may be relatively new or may have a bad record of activity.

FIG. 1C illustrates a process 100C of detecting that a recommended action has been completed and modifying a profile in response according to examples and features of the instant solution. Referring to FIG. 1C, the software application 122 may monitor usage data of the profile 130 to determine if the recommended action that is presented to the user of the profile 130 in the example of FIG. 1B, has been completed, achieved, satisfied, etc. For example, the software application 122 may continuously monitor the activity performed with the profile 130 with the software application 122, the external network 140, and the like, which is stored within the activity database 126, and determine whether the recommended action has been completed.

When the software application 122 detects the recommended action being completed from the activity that is stored within the activity database 126, the software application 122 may modify the profile 130 to generate a modified profile 130b. The modifications to the profile 130 may include changes that lessen restrictions on the profile's ability to perform activities with the software application 122, activities with data, activities with credit including increasing credit limits on payment accounts, increasing messaging amounts per cycle, streaming activities, downloading activities, and the like.

FIG. 1D illustrates a process 100D of using the modified profile 130b during subsequent processing according to examples and features of the instant solution. Referring to FIG. 1D, the software application 122 may use the modified profile 130b in subsequent activities conducted with by the owner of the profile 130. For example, the front-end of the software application 122 may submit a request 114 to the gateway node 142 of the external network 140. The request may include a message, a data access request, a data storage request, a payment, a file, a stream of data, and the like. The external network 140 may process the request 114 and store results of the request 114 in the activity database 126.

For example, to process the request, the external network 140 may request a profile of the user from the software application 122. In response, the software application 122 may provide the modified profile 130b to the external network 140, or data such as values, content, and the like, from the modified profile 130b that can be used as criteria when processing requests by the external network 140. For example, the modified profile 130b may set limits or other restrictions on the usage of the profile 130 with the external network 140. The external network 140 may receive the modified profile 130b, or data from the modified profile 130b, and perform the activity in the request 114. The results of the activity may be stored in the activity database 126.

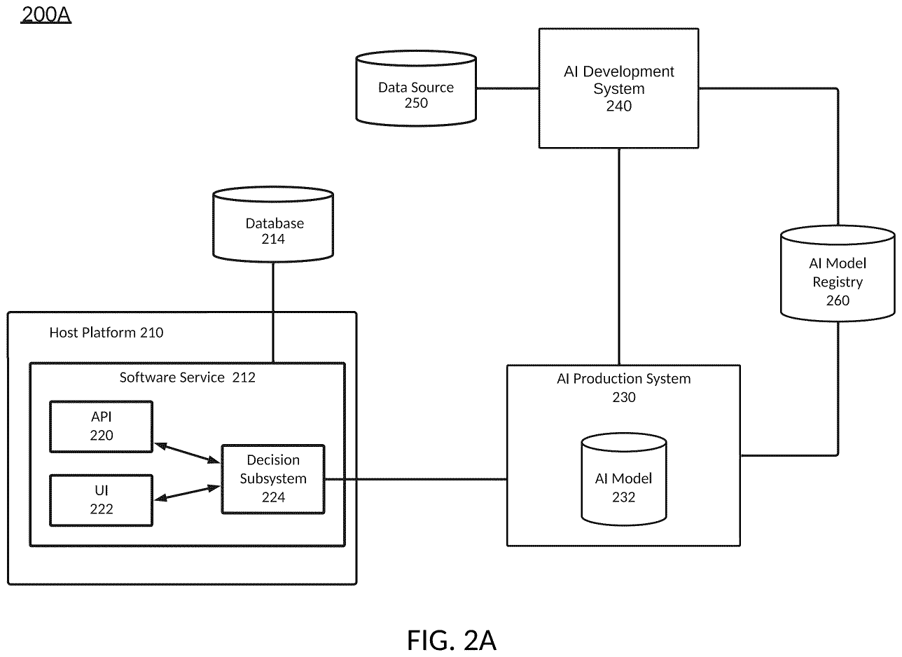

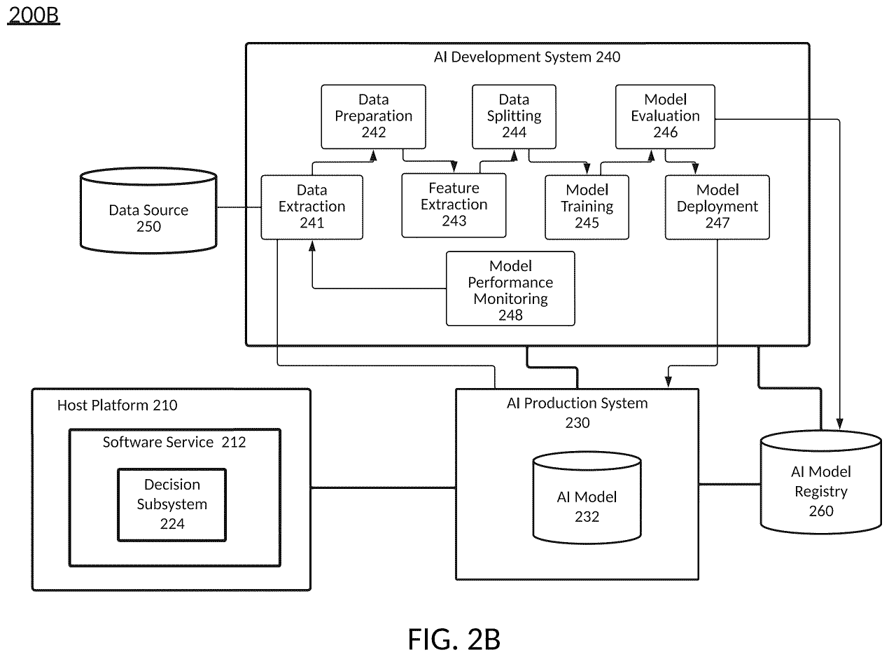

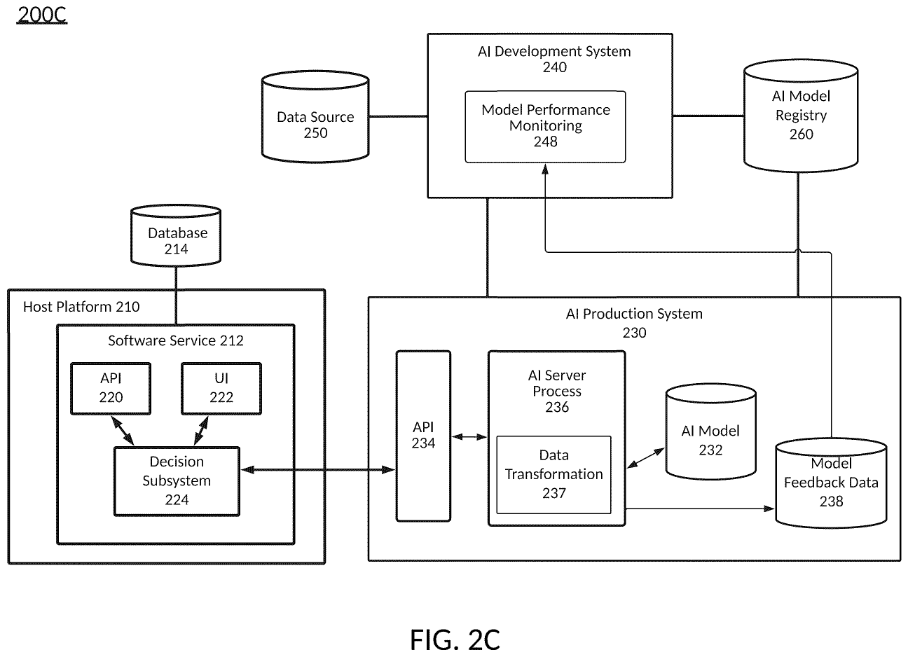

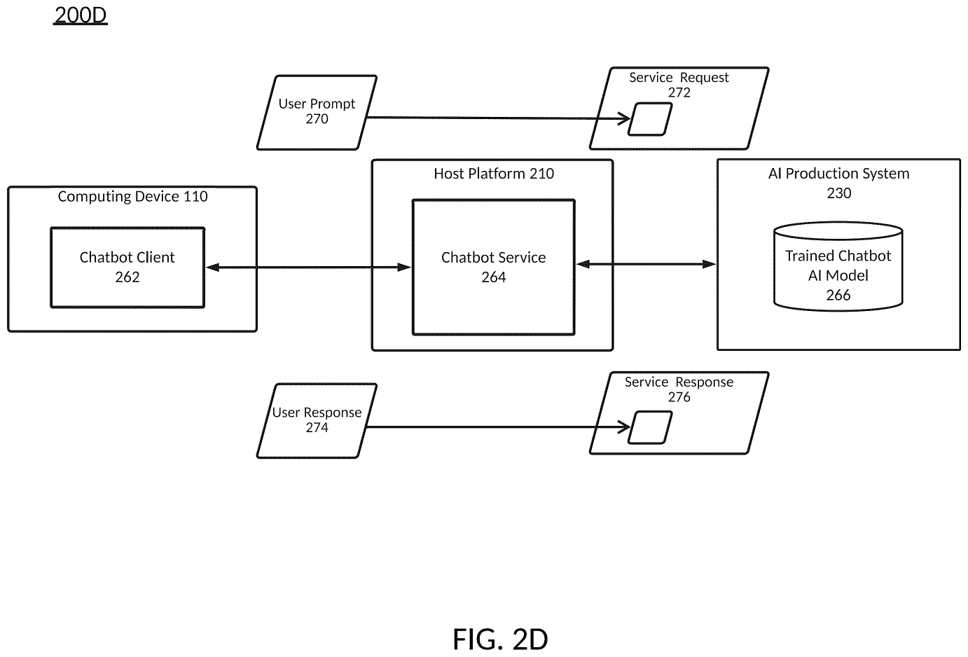

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 212 executing on host platform 210 may provide at least one A PI 220 that enable interaction with other software components via a set of data definitions and protocols. In some examples and features of the instant solution, the at least one API provided may employ Simple Object Access Protocol (SOAP), Remote Procedure Calls (RPC), and Representational State Transfer (REST) techniques. In some examples and features of the instant solution, the plurality of A Pls 220 send data to at least one decision subsystem 224 of the software service 212 to assist in decision-making. In some examples and features of the instant solution, the software service 212 stores data included in A PI requests or data generated during processing the API requests into at least one database 214. In some examples and features of the instant solution, software service 212 is a chatbot service.

Software service 212 may provide at least one user interface (UI) 222, such as a server-side hosted graphical user interface (GUI). In some examples and features of the instant solution, the UIs 222 provided employ template-based frameworks, component-based frameworks, etc. In some examples and features of the instant solution, these Uls 222 send data to at least one decision subsystem 224 of the software service 212 to assist with decision-making. In some examples and features of the instant solution, the software service 212 stores data included in UI requests or data generated during processing the UI requests into at least one database 214.

Software service 212 may include at least one decision subsystem 224 that drive a decision-making process of the software service 212. In some examples and features of the instant solution, the decision subsystems 224 receive data from at least one A PI 220 as input into the decision-making process. In some examples and features of the instant solution, a decision subsystem 224 may receive data from at least one UI 222 as input to the decision-making process. A decision subsystem 224 may gather service configuration or historical execution data from at least one database 214 to aid in the decision-making process. A decision subsystem 224 may provide feedback to an A PI 220 or a UI 222.

An AI production system 230 may be used by a decision subsystem 224 in a software service 212 to assist in its decision-making process. The AI production system 230 includes at least one AI model 232 that is executed to generate a response, such as, but not limited to, a prediction, a categorization, a UI prompt, etc. In some examples and features of the instant solution, the AI model 232 has been trained to provide chatbot responses. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The data sources 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing at least one AI model that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to at least one data transformation being employed to normalize at least one value in the dataset. In some examples and features of the instant solution, data deemed to be noisy is cleaned. A noisy dataset includes values that do not contribute to the training, such as, but not limited to, null and long string values. Data preparation 242 may be a manual process or an automated process using at least one of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using at least one of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to at least one algorithm parameter until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, at least one unseen validation dataset is used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using at least one of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes at least one trigger that results in the AI model 232 being updated by repeating steps 241-248 with updated data from at least one data source 250.

Referring to FIG. 2B, the AI-powered credit limit increase (CLI) system is structured around a multi-layered credit risk model that leverages deep learning algorithms to analyze extensive datasets, including customer spending patterns, transaction history, repayment behavior, and macroeconomic indicators. The AI ML Production System 230 processes da inputs received from various sources, including user interactions and real-time financial activities, and stores relevant behavioral data in Database 214.

The Decision Subsystem 224 applies predictive analytics to assess a user's financial behavior and determine personalized CLI recommendations. This decision-making framework is continually refined through iterative optimization in the AI ML Development System 240, where risk evaluations and credit pool assignments undergo continuous recalibration. To ensure the reliability and regulatory compliance of AI-driven CLI decisions, a Model Performance Monitoring 248 component evaluates model accuracy and effectiveness over time.

The system may integrate a GUI that dynamically presents real-time recommendations on financial actions that users can take to improve their creditworthiness. The GUI provides updates on risk scores, highlighting behavioral factors that impact CLI eligibility, such as maintaining optimal credit utilization ratios and making early repayments. Once a user meets predefined eligibility thresholds, the system generates an immediate CLI offer via GUI, ensuring that explicit user consent is obtained in compliance with regulatory requirements. The AI model features self-learning capabilities, allowing it to adapt CLI recommendations based on evolving financial trends and user-specific behavioral patterns. By continuously refining credit risk assessments, the system enhances the precision and personalization of CLI offers, thereby optimizing financial outcomes for users.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an A PI 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include A PI 220 data from software service 212, UI 222 data from software service 212 or data from other software service 212 subsystems (not shown).

Upon receiving the A PI 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the A PI requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the A PI 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to, a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

FIG. 2D illustrates a process 200D of a chatbot service that utilizes an AI model. Referring to FIG. 2D, a computing device 110 may host a chatbot client 262 which interworks with a chatbot service 264 executing on the host platform 210. Further, the chatbot service 264 utilizes a trained chatbot AI model 266 that is resident on an AI production system 230. In some examples and features of the instant solution, the chatbot client 262 is an example of a service client. In some examples and features of the instant solution, the chatbot service 264 is an example of software service 212 which includes an A PI 220, a UI 222 and at least one decision subsystem 224. In some examples and features of the instant solution, the trained chatbot AI model 266 is an example of AI model 232 which is hosted on an AI production system 230. In some examples and features of the instant solution, the AI production system 230 includes the internal architectural elements depicted in FIG. 2C.

The chatbot client 262 accepts and captures a user prompt 270 which it sends to the chatbot service 264. Upon receiving the user prompt 270, the chatbot service 264 builds a service request 272 that includes the user prompt 270. In some examples and features of the instant solution, the service request 272 may include a target AI model identifier, such as an identifier to a trained chatbot AI model 266. Once built, the service request 272 is delivered to the AI production system 230. Upon receipt of the service request 272, the AI production system 230 determines the target AI model, such as the trained chatbot AI model 266, and extracts the user prompt 270. In some examples and features of the instant solution, the AI production system transforms the user prompt 270 using Natural Language Understanding (NLU) or Natural Language Processing (NLP) techniques before delivering it to the trained chatbot AI model 266. Upon receipt of the possibly transformed user prompt 270, the trained chatbot AI model 266 determines an appropriate user response 274 and returns the user response 274 to the AI production system 230. In some examples and features of the instant solution, the trained chatbot AI model 266 utilizes neural networks or Natural Language Generation (NLG) techniques in order to determine the appropriate user response 274.

Upon receipt of the response, the AI production system 230 constructs and sends a service response 276 that contains the user response 274 back to the chatbot service 264. Upon receipt of the service response 276, the chatbot service 264 extracts the user response 274 and delivers it to the chatbot client 262, which emits it.

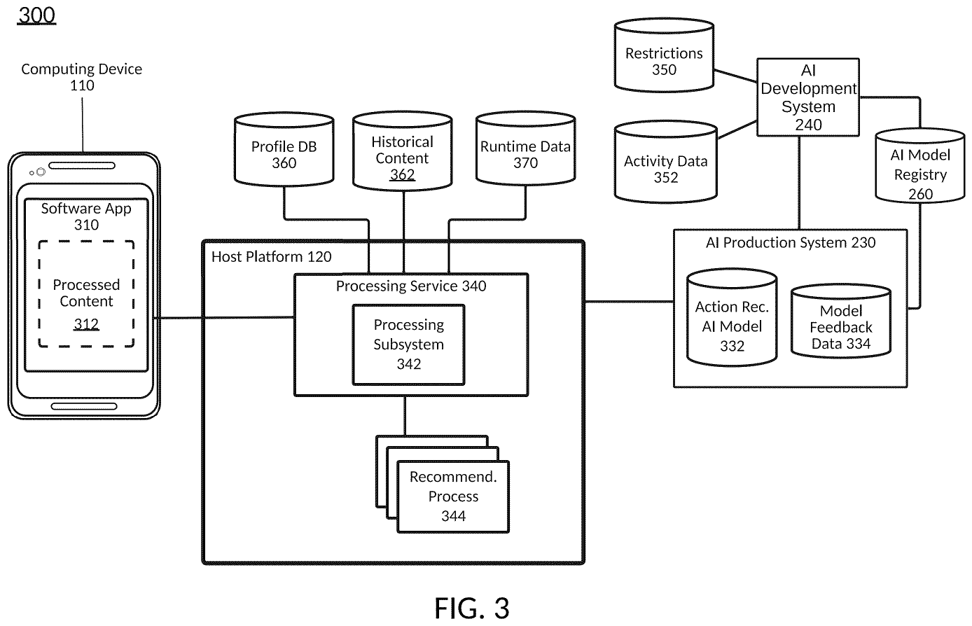

FIG. 3 illustrates an operating environment 300 for a communication service according to the examples and features of the instant solution. In some examples and features of the instant solution, an action recommendation AI model 332 is trained using at least one of historical usage of a profile, historical restrictions applied to profiles, historical thresholds for removing restrictions, and the like, to generate an action that can be performed by a profile to have at least one restriction lifted, removed, or otherwise reduced by the system. The action recommendation AI model 332 is an example of AI Model 232 (see, for example, FIGS. 2A-2C). historical usage of a profile, historical restrictions applied to profiles, historical thresholds for removing restrictions, runtime data including feedback are examples of data source 250 (see, for example, FIGS. 2A-2C). The training of the action recommendation AI model 332 may be evaluated based on restrictions 350, activity data 352, and the like.

In some examples and features of the instant solution, the action recommendation AI model 332 is trained using at least one neural network training method such as, but not limited to, gradient descent, stochastic gradient descent, random search, uniform search, basin hopping, and Krylov. In some examples and features of the instant solution, the action recommendation AI model 332 is a single or multi-layer perceptron neural network, a feed-forward neural network, a radial basis functional neural network, a recurrent neural network, or a modular neural network.

In some examples and features of the instant solution, the action recommendation AI model 332 may include, but is not limited to, at least one of a machine learning model, a deep learning model, a neural network, any combination of models from the branches of AI, and the like, and it may be trained using at least one of the respective training methods for machine learning models, deep learning models, neural networks, any combination of models from the branches of AI, and the like. In some examples and features of the instant solution, the training data for the action recommendation AI model 332 may include, but is not limited to, internal data sources, external data sources, private data sources, public data sources, historical call scripts, historical profile data, runtime data including feedback, historical communication content, profile data, and the like.

In some examples and features of the instant solution, historical profile data may include events, usage, activity, transactions, payments, messaging behavior, messaging content, registered content, transferred data streamed data, and the like. The runtime data may include feedback that is automatically captured by the software and/or that is received from a GUI, etc.

The model feedback records in the model feedback data 334 may include, but is not limited to, inputs entered via a GUI which indicate whether the action recommended by the action recommendation AI model 332 was helpful. As another example, the feedback may be determined automatically, for example, based on how long it takes a recommended action to be completed by a profile. As another example, the model feedback data 334 may include data that is automatically detected by the software application. For example, the software application may detect a change in conversation and infer that the response provided by the action recommendation AI model 332 solved the issue, etc.

Once the action recommendation AI model 332 is trained and validated, it is deployed to an AI production system 230 (see, for example, FIGS. 2A-2C, 3) for use by a processing service 340. The processing service 340 is an example of software service.

In some examples and features of the instant solution, software app 310, running on computing device 110, is an example of service client. The software app 310 may be a teleconferencing software application, a messaging software application, a chat software application, a call center software application, a payment application, and/or the like. The software app 310 may enable users to speak with each other over a network such as a cellular telephone network, the Internet, and the like. The software app 310 may also display content on a GUI of the software app 310, such as processing content 312. The software app 310 may also display content generated by the action recommendation AI model 332.

In some examples and features of the instant solution, the processing service 340 receives data from the software app 310. The data may include, but is not limited to, call scripts, images, text, audio, and the like.

Additionally, the processing service 340 receives data about the computing device 110. The device data may include, but is not limited to, the media access control (MAC) address and the source internet protocol (IP) address of the computing device.

For example, the processing service 340 may receive a communication from a software application such as an electronic message, an electronic form, application data, payment transaction, or the like. The processing service 340 may instantiate a processing subsystem 342 which extracts content from the communication and determines whether or not to the content is allowed to be sent to an exterior AI system. When the processing subsystem 342 determines to process the content, the processing subsystem 342 executes a recommendation process 344 which may call the action recommendation AI model 332 in the AI production system 230 for a recommended action for a profile to perform that can be displayed, spoken, or the like, within the software app 310. The call to the AI production system 230 may include content from the received communication. The content may include natural language content, transaction content, data from a profile database 360, a historical activity content database 362, a runtime database 370, and the like, in addition to the communication content.

In response to receiving the call, the action recommendation AI model 332 may generate a response to the input communication content that may include at least one of an utterance, a phrase, a script, a source code program, and the like, which can be output during the conversation. The response may be provided to the processing service 340 and output to a GUI of the software app 310, spoken by a talking bot via the software app 310, and the like.

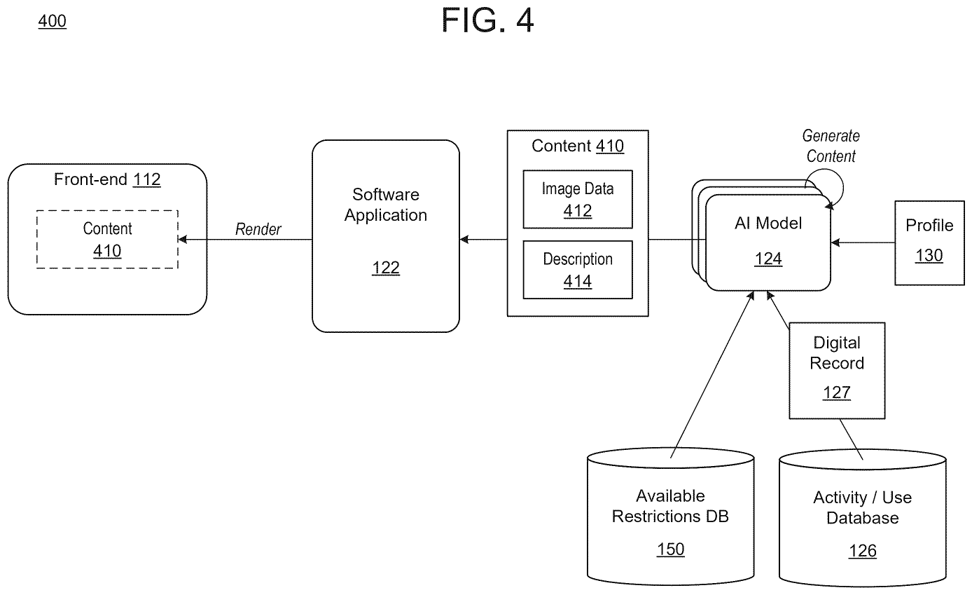

FIG. 4 illustrates a process 400 of generating content 410 for a notification and pushing the content 410 to a front-end 112 on the computing device according to the examples and features of the instant solution. Referring to FIG. 4, the software application 122 may continuously analyze a digital record 127 of use of a profile 130 and determine if there is an action, a goal, a predefined account balance, a predefined number of transactions, a predefined amount of data consumption, or the like, that can be performed with the profile 130 to cause the software application 122 to remove or reduce at least one restriction on the profile 130.

In this example, the at least one AI model 124 may ingest a current status of the digital record 127 from the activity database 126, and determine an action that can be taken to remove or reduce the at least one restriction on the profile 130. The at least one AI model 124 may generate content 410 with information about the action to be taken. The content 410 may include unique content that is generated by the at least one AI model 124 from known content such as historical action content, historical image content, and the like. For example, the content 410 may include image data 412 and/or text content (description 414).

The content 410 may be output by the at least one AI model 124 submitted to the software application 122. Here, the software application 122 may render the content 410 on a graphical user interface (GUI) of the front-end 112. As another example, the software application 122 may generate an electronic message such as a short messages service (SMS) message, an email message, and the like, and push the electronic message to an inbox, a phone number, a uniform resource locator (URL), and the like.

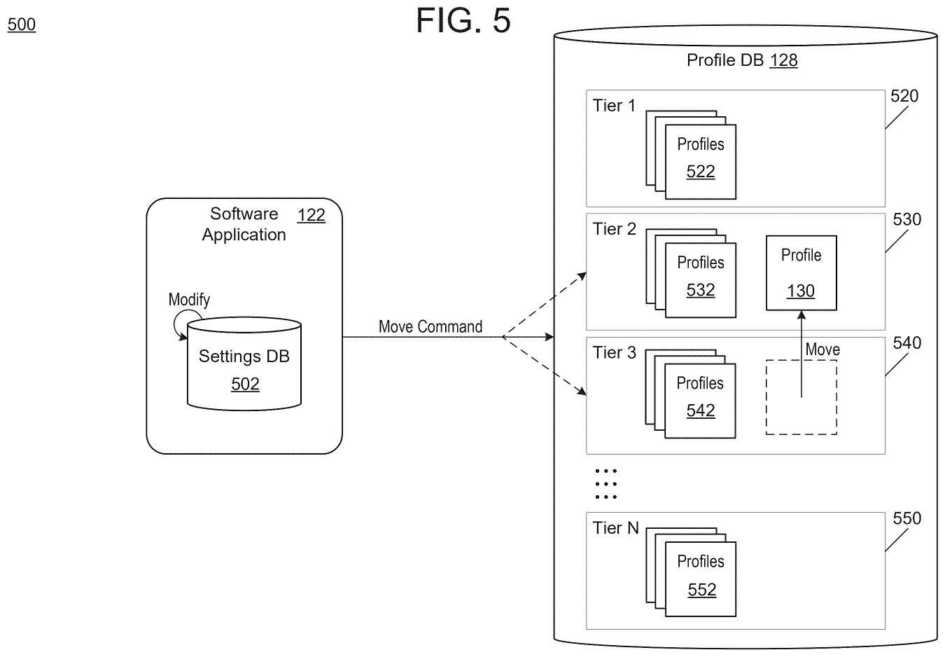

FIG. 5 illustrates a process 500 of changing settings within the software application 122 for the profile 130 and changing a storage location of the profile 130 within a storage device according to the examples and features of the instant solution. Referring to FIG. 5, the software application 122 may determine to modify at least one setting 502 inside of the software application 122 with respect to the profile 130. For example, the software application 122 may increase activities that can be performed with the profile 130 using at least one of the software application 122, the external network 140, and the profile 130. As another example, the software application 122 may modify communication capabilities, streaming capabilities, messaging capabilities, credit limits on payment accounts, personal information stored in the profile 130, and the like.

In addition or instead, the software application 122 may change a storage location of the profile 130 within the profile database 128. As an example, profiles may be stored in different memory pools within the profile database 128. Each memory pool may be associated with a different tier of profile. The different tiers correspond to different restrictions and/or limitations on the profile. In this example, the software application 122 may modify the profile 130 by simply moving the storage location of the profile 130 into a different memory pool corresponding to a different tier in the profile database 128 which automatically grants the profile 130 access to additional functionality, features, credit, and the like, associated with the different tier.

In the example of FIG. 5, the profile database 128 includes a top tier 520 with the least restrictions, and a plurality of lower tiers (eg., tier 530, tier 540, tier 550, etc.) which include more restrictions and/or limitations than the top tier 520. In this example, the tier 520 includes a set of profiles 522 stored therein, the tier 530 includes a set of profiles 532, the tier 540 includes a set of profiles 542, and the tier 550 includes a set of profiles 552.

Each tier down may include more restrictions and or limitations than the previous tier above in the drawing in FIG. 5. By moving the profile 130 from the set of profiles 542 stored in the memory pool of the tier 540 to the set of profiles 532 in the memory pool of the tier 530 thereby removing the restrictions on the profile 130 that are assigned by the tier 540 and applying a different set of restrictions to the profile 130 that are assigned to the tier 530.

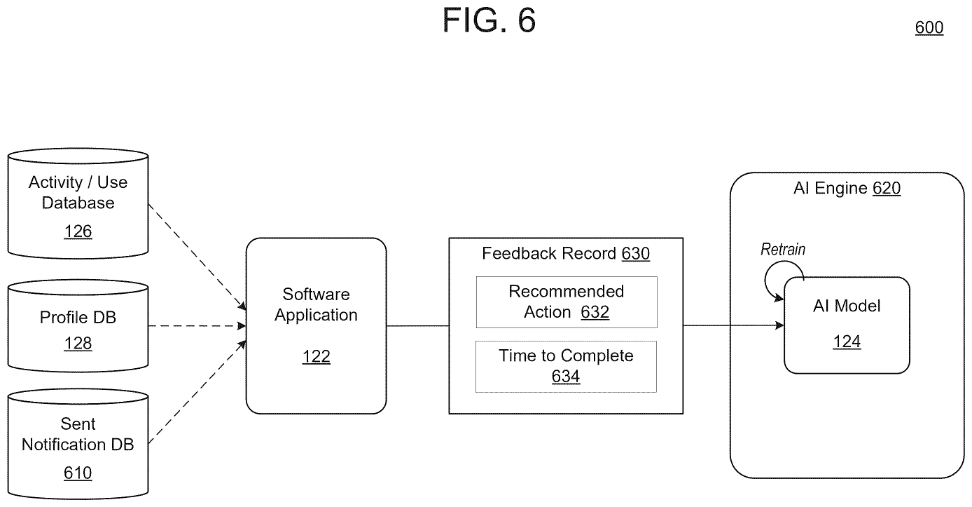

FIG. 6 illustrates a process 600 of generating a feedback record 630 and retraining an AI model 124 according to the examples and features of the instant solution. Referring to FIG. 6, the software application 122 may ingest data about the profile 130 from at least one of an activity database 126, the profile database 128, a sent notification database 610 (including recommended actions to take, etc.), and generate a feedback record 630 based on the data. For example, the feedback record 630 may include a recommended action 632 generated by the AI model 124, a time to complete 634 the recommended action 632 by the profile, and the like.

In this example, the software application 122 inputs the feedback record 630 to an AI engine 620 which causes the AI model 124 to execute on the feedback record 630 thereby retraining the AI model 124 based on the feedback record 630. The resulting retrained model can be used for subsequent profile action recommendations.

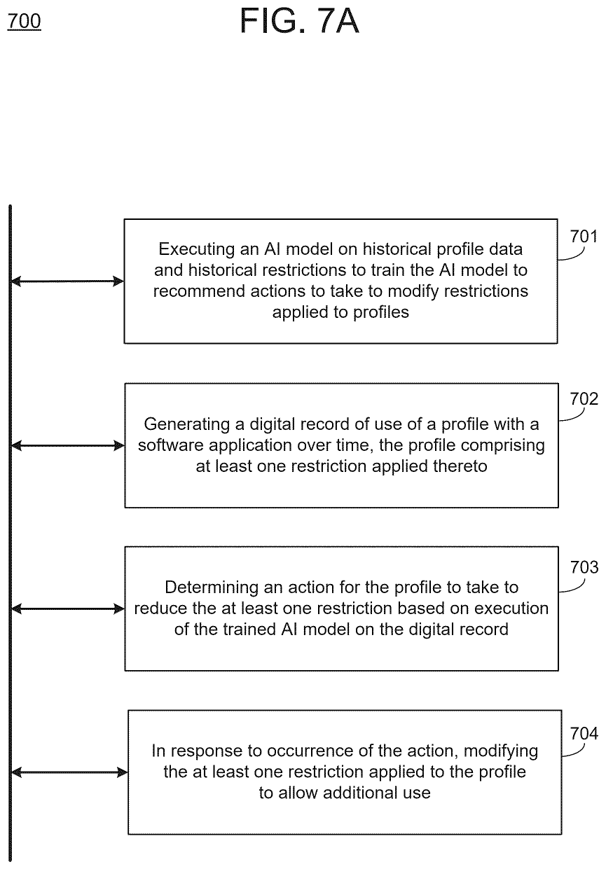

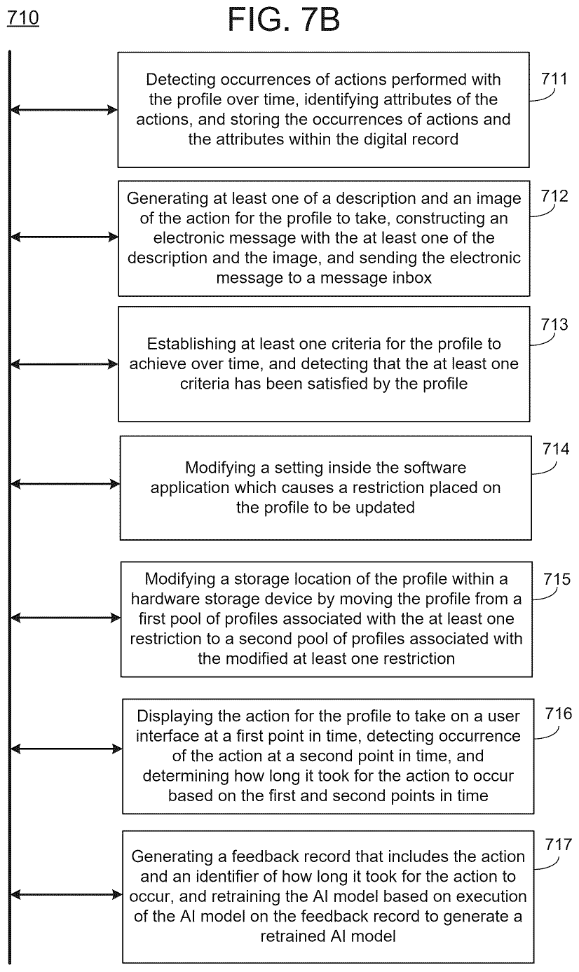

FIG. 7A illustrates a method 700 of modifying a restriction applied to a profile according to the examples and features of the instant solution. As an example, the method 700 may be performed by a computing system, a software application, a server, a cloud platform, a combination of systems, and the like. Referring to FIG. 7A, in 701, the method may include executing an AI model on historical profile data and historical restrictions to train the AI model to recommend actions to take to change restrictions applied to profiles. In 702, the method may include generating a digital record of use of a profile with a software application over time, the profile including at least one restriction applied thereto/In 703, the method may include determining an action for the profile to take to reduce the at least one restriction based on execution of the trained AI model on the digital record. In response to occurrence of the action, in 704, the method may include modifying the at least one restriction applied to the profile to allow additional use.

FIG. 7B illustrates an additional method 710 of modifying a restriction applied to a profile according to the examples and features of the instant solution. As an example, the method 710 may be performed by a computing system, a software application, a server, a cloud platform, a combination of systems, and the like. Referring to FIG. 7B, in 711, the method may include detecting occurrences of actions performed with the profile over time, identifying attributes of the actions, and storing the occurrences of actions and the attributes of the actions within the digital record. In 712, the method may include generating at least one of a description and an image of the action for the profile to take based on execution of a second AI model on the digital record, constructing an electronic message with the at least one of the description and the image of the action for the profile to take, and sending the electronic message to a message inbox associated with the profile.

In 713, the method may include establishing at least one criteria for the profile to achieve over time, and detecting that the at least one criteria has been satisfied by the profile. In 714, the method may include modifying a setting inside the software application which causes a restriction placed on the profile to be updated. In 715, the method may include modifying a storage location of the profile within a hardware storage device based on the occurrence of the action by the profile, the modifying including moving the profile from a first pool of profiles associated with the at least one restriction to a second pool of profiles associated with the modified at least one restriction.

In 716, the method may include displaying the action for the profile to take on a user interface at a first point in time, detecting occurrence of the action at a second point in time, and determining how long it took for the action to occur based on a difference in time between the first point in time and the second point in time. In 717, the method may include generating a feedback record that includes the action and an identifier of how long it took for the action to occur, and retraining the AI model based on execution of the AI model on the feedback record to generate a retrained AI model.

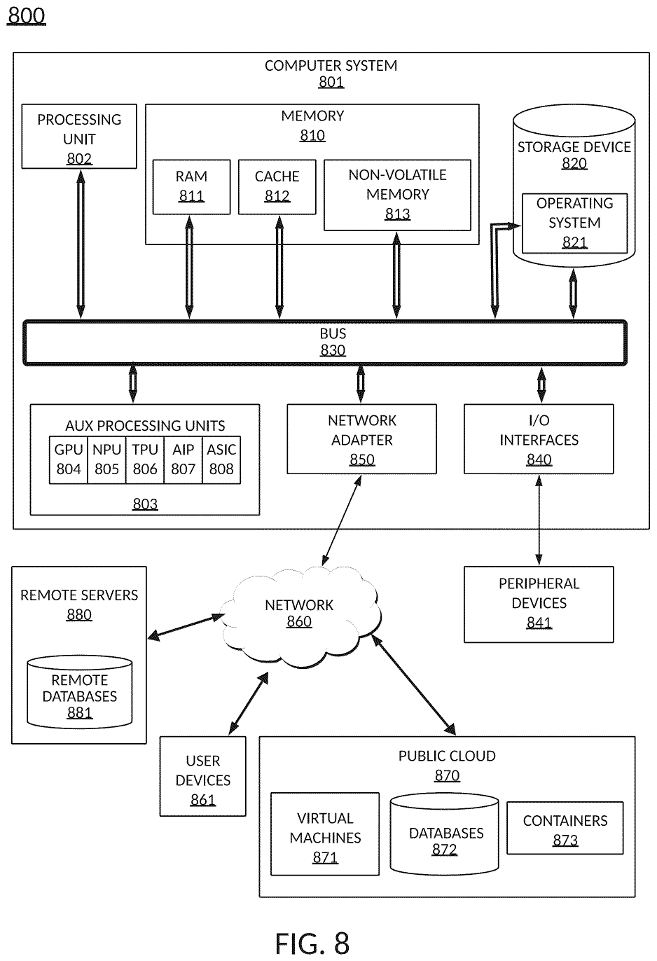

The examples and features of the instant solution may be implemented in at least one of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

A n exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. As shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

The Auxiliary Processing Units (A PU) 803 may contain at least one Graphics Processing Unit (GPU) 804, Neural Processing Unit (NPU) 805, Tensor Processing Unit (TPU) 806, AI Processor (AIP) 807, or other Application Specific Integrated Circuit (A SIC) 808. The at least one A PU 803 may contain circuitry distributed over multiple integrated circuit chips. Each A PU 803 may implement multiple processor threads and multiple processor cores. Each APU 803 may include at least one of onboard memory, onboard memory cache, and onboard instruction cache. Each A PU may be communicatively coupled to the system bus 830 and configure to communicate with other system components, including a processing unit 802, system cache 812, RAM 811, non-volatile RAM 813, operating system 821, Network adapter 850, and Input/Output interfaces 840. In some computing environments, at least one of the at least one A PU 803 may be designed to work with qubits and perform quantum computing.

Memory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (M CA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc. ; at least one device that enables a user to interact with computer system 801; and/or any devices (e.g., network card, modem, etc.) that enable computer system 801 to communicate with at least one other computing device. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN), a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LA Ns designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. U ser devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system A Pls and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by at least one of the modules or components described herein or in a distributed architecture and may include a transmitter, receiver, or pair of both. For example, all or part of the functionality performed by the individual modules may be performed by at least one of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via at least one of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise at least one physical or logical block of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus comprising:
a memory; and
at least one processor which is communicably coupled to the memory, wherein the at least one processor is configured to:
execute an artificial intelligence (AI) model on historical profile data and on historical restrictions to train the AI model to recommend actions to take to modify restrictions applied to profiles;
generate a digital record of use of a profile with a software application over time, the profile comprising at least one restriction applied thereto;
determine an action for the profile to take to reduce the at least one restriction based on execution of the trained AI model on the digital record; and
in response to occurrence of the action, modify the at least one restriction applied to the profile to allow additional use.

2. The apparatus of claim 1, wherein the at least one processor is configured to detect occurrences of actions performed with the profile over time, identify attributes of the actions, and store the occurrences of actions and the attributes of the actions within the digital record.

3. The apparatus of claim 1, wherein the at least one processor is further configured to generate at least one of a description and an image of the action for the profile to take based on execution of a second AI model on the digital record, construct an electronic message with the at least one of the description and the image of the action for the profile to take, and send the electronic message to a message inbox associated with the profile.

4. The apparatus of claim 1, wherein the at least one processor is configured to establish at least one criteria for the profile to achieve over time, and detect that the at least one criteria has been satisfied by the profile.

5. The apparatus of claim 1, wherein the at least one processor is configured to modify a setting inside the software application which causes the at least one restriction applied to the profile to be updated.

6. The apparatus of claim 1, wherein the at least one processor is configured to change a storage location of the profile within a hardware storage device based on the occurrence of the action by the profile, and move the profile from a first pool of profiles associated with the at least one restriction to a second pool of profiles associated with the at least one modified restriction, wherein an AI agent performs an action based on the at least one modified restriction.

7. The apparatus of claim 1, wherein the at least one processor is further configured to display the action for the profile to take on a user interface at a first point in time, detect occurrence of the action at a second point in time, and determine how long it took for the action to occur based on a difference in time between the first point in time and the second point in time.

8. The apparatus of claim 7, wherein the at least one processor is further configured to generate a feedback record that includes the action and an identifier of how long it took for the action to occur, and retrain the trained AI model based on execution of the trained AI model on the feedback record to generate a retrained AI model.

9. A method comprising:
executing an artificial intelligence (AI) model on historical profile data and on historical restrictions to train the AI model to recommend actions to take to modify restrictions applied to profiles;
generating a digital record of use of a profile with a software application over time, the profile comprising at least one restriction applied thereto;
determining an action for the profile to take to reduce the at least one restriction based on execution of the trained AI model on the digital record; and
in response to occurrence of the action, modifying the at least one restriction applied to the profile to allow additional use.

10. The method of claim 9, further comprising detecting occurrences of actions performed with the profile over time, identifying attributes of the actions, and storing the occurrences of actions and the attributes of the actions within the digital record.

11. The method of claim 9, further comprising generating at least one of a description and an image of the action for the profile to take based on execution of a second AI model on the digital record, constructing an electronic message with the at least one of the description and the image of the action for the profile to take, and sending the electronic message to a message inbox associated with the profile.

12. The method of claim 9, wherein the determining comprises establishing at least one criteria for the profile to achieve over time, and the method further comprises detecting that the at least one criteria has been satisfied by the profile.

13. The method of claim 9, wherein the modifying comprises modifying a setting inside the software application which causes the at least one restriction applied to the profile to be updated.

14. The method of claim 9, wherein the modifying comprises modifying a storage location of the profile within a hardware storage device based on the occurrence of the action by the profile, the modifying comprising moving the profile from a first pool of profiles associated with the at least one restriction to a second pool of profiles associated with the at least one modified restriction, wherein an AI agent performs an action based on the at least one modified restriction.

15. The method of claim 9, further comprising displaying the action for the profile to take on a user interface at a first point in time, detecting occurrence of the action at a second point in time, and determining how long it took for the action to occur based on a difference in time between the first point in time and the second point in time.

16. The method of claim 15, further comprising generating a feedback record that includes the action and an identifier of how long it took for the action to occur, and retraining the AI model based on execution of the AI model on the feedback record to generate a retrained AI model.

17. A computer-readable storage medium comprising instructions which when executed by a processor cause the processor to perform:
executing an artificial intelligence (AI) model on historical profile data and on historical restrictions to train the AI model to recommend actions to take to modify restrictions applied to profiles;
generating a digital record of use of a profile with a software application over time, the profile comprising at least one restriction applied thereto;
determining an action for the profile to take to reduce the at least one restriction based on execution of the trained AI model on the digital record; and
in response to occurrence of the action, modifying the at least one restriction applied to the profile to allow additional use.

18. The computer-readable storage medium of claim 17, wherein the processor is further configured to perform generating at least one of a description and an image of the action for the profile to take based on execution of a second AI model on the digital record, constructing an electronic message with the at least one of the description and the image of the action for the profile to take, and sending the electronic message to a message inbox associated with the profile.

19. The computer-readable storage medium of claim 17, wherein the modifying comprises modifying a setting inside the software application which causes the at least one restriction applied to the profile to be updated.

20. The computer-readable storage medium of claim 17, wherein the modifying comprises modifying a storage location of the profile within a hardware storage device based on the occurrence of the action by the profile, the modifying comprising moving the profile from a first pool of profiles associated with the at least one restriction to a second pool of profiles associated with the at least one modified restriction, wherein an AI agent performs an action based on the at least one modified restriction.
